(19) United States
(12) Patent Application Publication
(10) Pub. No.: US 2023/0169599 A1
(43) Pub. Date: Jun. 1, 2023

(54) INSURANCE PRODUCT AND METHOD FOR REAL ESTATE TRANSACTION

(71) Applicants: Donald Byrd, Camby, IN (US); Jarren Hurt, Camby, IN (US)

(72) Inventors: Donald Byrd, Camby, IN (US); Jarren Hurt, Camby, IN (US)

(21) Appl. No.: 17/914,619

(22) PCT Filed: Feb. 22, 2021
(86) PCT No.: PCT/US21/18970

§ 371 Date: Sep. 26, 2022

Related U.S. Application Data
(60) Provisional application No. 62/981,511, filed on Feb. 25, 2020.

(51) Int. Cl. G06Q 40/08; G06Q 50/16

(52) U.S. Cl. CPC G06Q 40/08; G06Q 50/16

(57) ABSTRACT

An insurance product for a real estate transaction includes a policy having terms and conditions for insurer compensation for losses incurred during the real estate transaction when the real estate transaction fails to close. A policyholder of the policy is a seller of real estate in the real estate transaction or a potential buyer of the real estate in the real estate transaction. An insured on the policy is the seller or the potential buyer. When a purchase agreement of the real estate transaction fails to close, a fault for the failure is identified based on predetermined criteria. When the fault is that of the seller, the buyer is compensated by an insurer for a set of covered buyer losses. When the fault is that of the buyer, the seller is compensated by the insurer for a set of covered seller losses.

### CROSS-REFERENCE TO RELATED APPLICATIONS

This patent application claims priority to co-pending U.S. Provisional patent application Ser. No. 62/981,511, filed on Feb. 25, 2020.

### TECHNICAL FIELD

The present disclosure relates to the field of insurance. More specifically, the present invention is directed to an insurance product and method for insuring one or both parties to a real estate transaction against losses when a real estate transaction fails to close.

### BACKGROUND

A typical real estate transaction includes a buyer making an offer on a property and a seller of the property deciding whether or not to accept the offer. The buyer may offer earnest money to the seller to cover losses that may occur during the real estate transaction under certain circumstances. For example, the seller may have the right to keep the earnest money in the event the buyer backs out of the transaction without a valid reason. In addition, the seller may keep the earnest money if the buyer doesn't adhere to an agreed upon timeframe.

The buyer generally provides the seller a pre-approval letter from a lender, or other insurer, that states the buyer will be able to obtain financing from the lender up to a certain amount. If the seller accepts the offer of the buyer, a purchase agreement is generally entered into between the buyer and seller. It the purchase agreement fails to close, the buyer and/or seller may experience a significant financial loss.

The present novel technology, which may be implemented to reduce financial loss as a result of the failed transaction.

### SUMMARY

An insurance product for a real estate transaction of the present disclosure includes a policy having terms and conditions for insurer compensation for losses incurred during the real estate transaction when the real estate transaction fails to close. A policyholder of the policy is a seller of real estate in the real estate transaction or a potential buyer of the real estate in the real estate transaction. An insured on the policy is the seller or the potential buyer. When a purchase agreement of the real estate transaction fails to close, a fault for the failure is identified based on predetermined criteria. When the fault is that of the seller, the buyer is compensated by an insurer for a set of covered buyer losses. When the fault is that of the buyer, the seller is compensated by the insurer for a set of covered seller losses.

A method for insuring a potential buyer or a seller for a real estate transaction of the present disclosure includes purchasing a policy including terms and conditions for insurer compensation for losses incurred during the real estate transaction when the real estate transaction fails to close. The method also includes a step of purchasing the policy by the potential buyer of real estate in the real estate transaction or the seller of the real estate in the real estate transaction as policyholder. The seller or the potential buyer may be identified as an insured on the policy. A fault for the failure of a purchase agreement of the real estate transaction may be identified based on predetermined criteria when the purchase agreement fails to close. The buyer is compensated by an insurer for a set of covered buyer losses when the fault is that of the seller, and the seller is compensated by the insurer for a set of covered seller losses when the fault is that of the buyer.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flow diagram illustrating an exemplary method, according to the present disclosure.

FIG. 2 is another flow diagram illustrating another exemplary method, according to the present disclosure, according to the present disclosure; and

FIG. 3 is another flow diagram illustrating yet another exemplary method, according to the present disclosure.

Like reference numbers and designations in the various drawings indicate like element.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not. Additionally, “generates,” “populates,” “generating,” and “populating” mean that rental property management system or module may produce some event or cause some event element to be produced. For example, a webpage may receive data to display in whole or in part to display a valuation estimate to an end digital, the webpage may pull such data from a source other than system (e.g., other servers, intermediaries, etc.), or system may entirely provide the valuation estimate to be produced on the webpage.

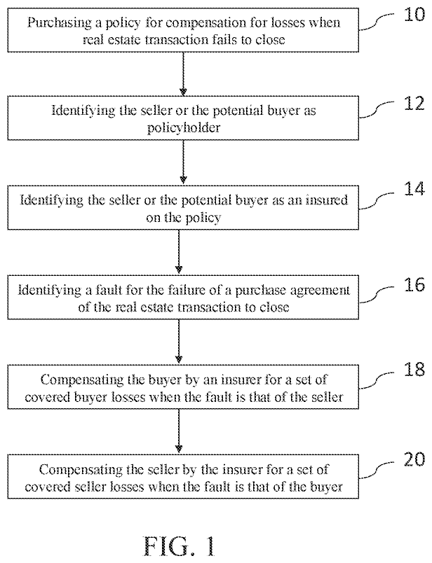

FIG. 1 is a flow diagram, or block diagram, referenced while describing the contents of the present disclosure. The disclosure relates to an insurance product for a real estate transaction. With respect to real estate, a typical transaction, or process, may include a potential buyer making an offer and a seller accepting or rejecting the offer.

A purchase agreement, in real estate, is a document that binds the potential buyer and the seller and outlines the details of the real estate transaction. Negotiations may go back and forth between the potential buyer and seller before both parties are satisfied. Once the parties agree, the purchase agreement is signed. Although a purchase agreement is a binding contract, there can be legitimate and/or unavoidable reasons, such as with respect to the potential buyer and seller, for trying to get out of the purchase agreement. These may be included in the purchase agreement and may enable a party to exit the deal without penalty.

That is, the purchase agreement may include one or more contingencies. One such contingency is a financing contingency stating that the sale is contingent on the buyer being able to obtain financing. This clause protects the buyer in the case they are unable to secure a mortgage. The next contingency is an inspection contingency where the buyer is able to back out of the sale without penalty if they aren't satisfied with a professional inspector's assessment of the home. Another contingency is an appraisal contingency, which states that the home must appraise at a value equal to or higher than what the buyer agreed to pay. The purchase agreement may also include a home sale contingency, which means the home purchase is contingent on the buyer's ability to sell their current home.

Regardless of these contingencies, very few remedies exist for losses incurred by the potential buyer and/or seller during a real estate transaction, or process, when a purchase agreement fails to close.

According to the present disclosure, and with reference to FIG. 1, an insurance product may be available for one or both parties to the purchase agreement. The insurance product may include an insurance policy, which is a contract between an insurer and a policyholder. The insurance policy may be used to determine the claims which the insurer is legally required to pay. In exchange for payment of a premium, the insurer promises to pay the insured for covered loss under the policy language. The insurance policy has terms and conditions for insurer compensation for losses incurred during the real estate transaction, such as those described herein, when the real estate transaction, or purchase agreement, fails to close. (at box 10).

A policyholder, according to the present disclosure, may purchase the policy and be responsible for premium payments. (at box 12). As will be described further below, the policyholder may be one or both of the potential buyer and the seller. An insured on the policy may be the potential buyer and/or the seller. According to some embodiments, the insured may be both the seller and the potential buyer, on one or more different policies. In addition, the potential buyer may be both insured and policyholder and/or the seller may be both insured and policyholder. (at box 14).

The potential buyer and/or seller may apply for and/or may agree to purchase real estate transaction insurance, which may be offered, for example, by an agent, mortgage finance company, lender or other, which may function as the insurer. The policy may be paid up front or be paid at closing depending on which options the parties choose.

When a purchase agreement of the real estate transaction fails to close, a fault for the failure is identified based on predetermined criteria. (at box 16). When the fault is that of the seller, the buyer may be compensated by the insurer for a set of covered buyer losses. (at box 18). Seller faults may include failures due to the inspection and the appraisal and may be capped at a maximum amount or not capped. Covered buyer losses may include inspection fee, appraisal fee, etc.

When the fault is that of the buyer, the seller is compensated by the insurer for a set of covered seller losses. (at box 20). Buyer faults may include the buyer backing out of the real estate transaction without reason. Covered seller losses may include days off of the market and purchase agreement price. If the transaction closes, however, insurance proceeds may not be paid to the seller and/or potential buyer.

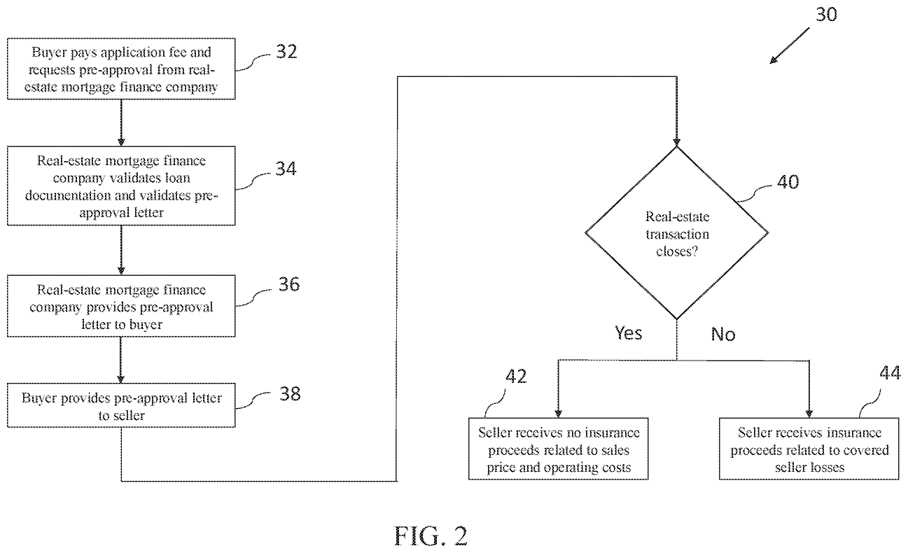

FIG. 2 illustrates a “seller only” option for the insurance product. (at box 30). According to this example, a potential buyer may submit application information to obtain the insurance product, or real estate transaction insurance, to protect the seller during the real estate transaction. (at box 32). The potential buyer completes an insurance application indicating loan amount intended to acquire, provides financial information etc. to the entity offering the insurance. The real estate mortgage financing company, or other entity, validates the loan documentation and validates the pre-approval letter. (at box 34).

The potential buyer may or may not be given an option to pay at the time of coverage acceptance or at closing if the potential buyer is approved. The insurer provides the potential buyer with the pre-approval letter. (at box 36). The potential buyer provides an insured pre-approval letter to the seller, along with or separate from an offer. (at box 38). The seller is now protected against losses as outlined in the pre-approval letter. If the real estate transaction, or purchase agreement, closes, (at box 40), the seller receives no insurance proceeds related to sales price and operating costs. (at box 42). However, if the real estate transaction fails to close, the seller may receive insurance proceeds related to covered seller losses. (at box 44).

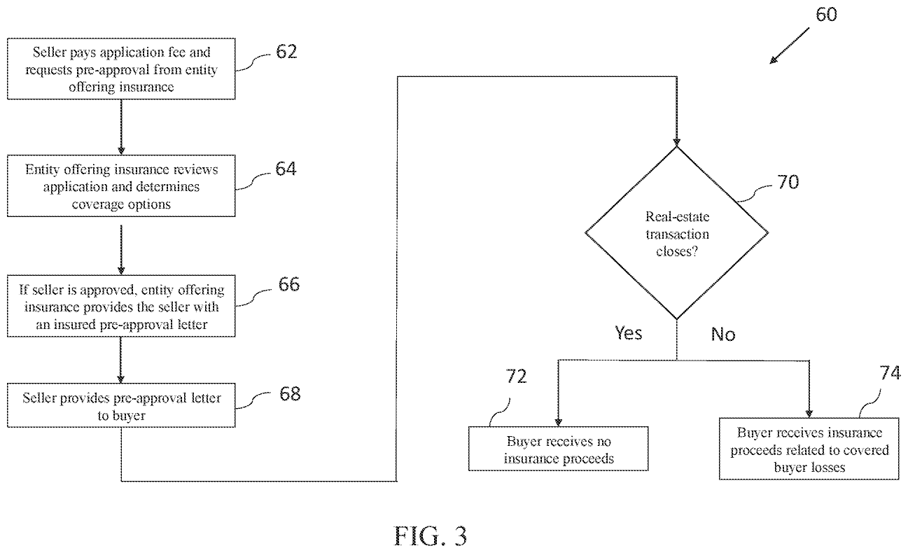

FIG. 3 illustrates a “buyer only” option. (at box 60). The seller submits application information to obtain real estate transaction insurance to protect the potential buyer. (at box 62). The seller completes insurance application indicating loan amount intended to acquire, provides financial information etc. to the entity offering insurance. (at box 64). The real estate mortgage financing company validates loan documentation and pre-approval letter.

The seller may or may not be given an option to pay at time of coverage acceptance or at closing. If the potential buyer is approved, insurer provides the potential buyer with the insured pre-approval letter. (at box 66). The seller provides an insured pre-approval letter to the buyer along with an offer. (at box 68). The buyer is now protected against losses as outlined in the pre-approval letter. It is determined whether or not the real estate transaction, or purchase agreement, closed (at box 70), the buyer receives no insurance proceeds related to sales price and operating costs if the real estate transaction closed (at box 72). However, if the real estate transaction fails to close, the buyer may receive insurance proceeds related to covered buyer losses. (at box 74).

If the transaction does not close, and it is within the control of seller and/or potential buyer, insurance proceeds may not compensate the seller, potential buyer, or both. If it is in control of the seller, the seller may not be compensated, but the potential buyer may or may not be compensated. If it is in control of the potential buyer, the potential buyer may not be compensated, but the seller may or may not be compensated. If it is in control of both the buyer and seller, both the buyer and seller may not be compensated.

A basic coverage policy may compensate the seller due to financing failure or other factors outside of the potential buyer's or seller's control. That is, the failure is not the fault of the buyer or seller. Or, a basic coverage policy may compensate the potential buyer due to financing failure or other factors outside of the potential buyer's or seller's control. A full coverage policy may compensate both the seller and the potential buyer due to financing failure or other factors outside of the buyer's and/or seller's control.

Particular embodiments of the subject matter have been described. Other embodiments are within the scope of the following claims.

What is claimed is:

1. An insurance product for a real estate transaction, including:
a policy including terms and conditions for insurer compensation for losses incurred during the real estate transaction when the real estate transaction fails to close;
wherein a policyholder of the policy is a seller of real estate in the real estate transaction or a potential buyer of the real estate in the real estate transaction;
wherein an insured on the policy is the seller or the potential buyer;
when a purchase agreement of the real estate transaction fails to close, a fault for the failure is identified based on predetermined criteria;
when the fault is that of the seller, the buyer is compensated by an insurer for a set of covered buyer losses; and
when the fault is that of the buyer, the seller is compensated by the insurer for a set of covered seller losses.

2. The insurance product of claim 1, wherein the policyholder is the potential buyer, and the insured is the seller.

3. The insurance product of claim 2, wherein the insured are the seller and the potential buyer.

4. The insurance product of claim 1, wherein the policyholder is the seller, and the insured is the potential buyer.

5. The insurance product of claim 4, wherein the insured are the potential buyer and the seller.

6. The insurance product of claim 1, wherein the policyholders are the potential buyer and the seller, and the insured are the potential buyer and the seller.

7. The insurance product of claim 1, wherein potential buyer faults include the buyer backing-out of the real estate transaction.

8. The insurance product of claim 1, wherein seller faults include failure Due to inspection and failure due to appraisal.

9. The insurance product of claim 1, wherein covered buyer losses include inspection fee and appraisal fee.

10. The insurance product of claim 1, wherein covered seller losses include days off market and purchase agreement price.

11. A method for insuring a buyer or a seller for a real estate transaction, wherein the method includes steps of:
purchasing a policy including terms and conditions for insurer compensation for losses incurred during the real estate transaction when the real estate transaction fails to close;
purchasing the policy by a potential buyer of real estate in the real estate transaction or a seller of the real estate in the real estate transaction;
identifying the seller or the potential buyer as an insured on the policy;
identifying a fault for the failure of a purchase agreement of the real estate transaction to close based on predetermined criteria;
compensating the buyer by an insurer for a set of covered buyer losses when the fault is that of the seller; and
compensating the seller by the insurer for a set of covered seller losses when the fault is that of the buyer.

12. The method of claim 11, wherein the policyholder is the potential buyer, and the insured is the seller.

13. The method of claim 12, wherein the insured are the seller and the potential buyer.

14. The method of claim 11, wherein the policyholder is the seller, and the insured is the potential buyer.

15. The method of claim 14, wherein the insured are the potential buyer and the seller.

16. The method of claim 11, wherein the policyholders are the potential buyer and the seller, and the insured are the potential buyer and the seller.

17. The method of claim 11, wherein potential buyer faults include the buyer backing-out of the real estate transaction.

18. The method of claim 11, wherein the seller faults include failure due to inspection and failure due to appraisal.

19. The method of claim 11, wherein covered buyer losses include inspection fee and appraisal fee.

20. The method of claim 11, wherein covered seller losses include days off market and purchase agreement price.
